(19) United States
(12) Patent Application Publication
(10) Pub. No.: US 2022/0405790 A1
(43) Pub. Date: Dec. 22, 2022

(54) VIRTUALIZED WHOLESALING

(71) Applicant: Pod Foods Co., San Francisco, CA (US)

(72) Inventors: Larissa Russell, Los Angeles, CA (US); Fiona Lee, Chicago, IL (US)

(21) Appl. No.: 17/591,292

(22) Filed: Feb. 2, 2022

Related U.S. Application Data
(63) Continuation-in-part of application No. 17/349,378, filed on Jun. 16, 2021.

(51) Int. Cl. G06Q 30/02

(52) U.S. Cl. CPC G06Q 30/0206; G06Q 30/0264; G06Q 30/0205

(57) ABSTRACT

In virtualized wholesaling, orders may be filled without pre-stocked product, and rapidly enough for the product to be on the retailer's shelf in a just-in-time (JIT) fashion that benefits the manufacturer/vendor. The virtualized wholesaler can promote sales without requiring substantial pre-stocking of products that may not have a large-volume presence, and the retailer can exploit long-tail economics to increase its variety of product offerings and reach specific, often niche products and consumers with reduced risk of dead shelf space. Various use cases incorporate enhanced product support, user experience, and third-party solutions.

### BACKGROUND

Legacy wholesaling presents a bottleneck for manufacturers, vendors, and retailers alike. Where a legacy wholesaler has inherent resource limitations, ranging from physical space in warehouses to negotiable relationships, a wholesaler is obliged to maximize return by selecting what it perceives to be the best selling, high sales volume items. Consequently, a legacy wholesaler who expends resources to place a newly established or niche product may suffer an opportunity cost from not selling a higher volume, non-niche product. Similar considerations drive retailers toward high-volume products; they may be unaware of certain niche products unless exposed to them by a consumer customer or the manufacturer/vendor themselves, and, even if aware, absent a ready supply at the wholesaler, the retailer has little incentive to devote valuable shelf space to an unproven or specialized product.

Correspondingly, manufacturers and vendors of niche items are constrained in product distribution and placement. For a manufacturer or vendor of a niche product, wholesaling may be limited to niche wholesalers or even shut out of wholesaling entirely. As a result, all parties (manufacturers, vendors, wholesalers, and retailers) may suffer from limited opportunities to build relationships with one another. Accordingly, niche products can be denied meaningful access to a significant portion of the general market.

On the other hand, with the advent of e-commerce, online retailers do not suffer from such constraints. Because online retailers do not have physical shelf space, they can surface through their product search engines a relatively unconstrained number and variety of products. Even a bricks-and-mortar bookstore, for example, that might formerly have placed perhaps the thousand best-selling books, can expand its offerings through online sales so as also to offer the next million best-selling books. In other words, because it has virtualized shelf space, the bookstore can realize sales on both best-sellers and non-best sellers, turning what at best might be a loss-leading proposition into profitable sales; even though number of sales of non-best-sellers may be few, the retailer can “make it up on volume,” a phenomenon known as “long-tail economics.”

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates an example architecture for implementing a platform that matches retailers with vendors.

FIG. 2 illustrates various components of a server that implements virtualized wholesaling.

FIG. 3 is a flow diagram of an example process performed at least in part by the server for implementing product and/or brand recommendations to a retailer.

FIG. 4 is a flow diagram of an example process performed at least in part by the server for implementing virtualized wholesaling of a vendor's product offerings.

FIG. 5 is a flow diagram of an example process performed at least in part by the server for implementing predictive analytics and machine learning.

FIG. 6 illustrates an example of an architecture for implementing embodiments of virtualized wholesaling.

FIG. 7 illustrates examples of end-user clients that have access to data powered services such as those shown in the architecture of FIG. 6.

### DETAILED DESCRIPTION

The situation described above presents itself as an opportunity for newly established or niche manufacturers and vendors to enter a market previously closed to them, or at least one in which it would be difficult to gain any traction. One way to do this would be for the manufacturer or vendor to be able to make its products visible and available to retailers even in the absence of pre-existing relationships and/or large-volume demands. A virtualized wholesaler as described herein can step in to fulfill orders efficiently even without pre-stocked product, and rapidly enough for the product to be on the retailer's in a just-in-time (JIT) fashion that benefits the manufacturer/vendor (who is freed from key constraints in finding an outlet), the wholesaler (who can promote sales without requiring substantial pre-stocking of products that may not have a large-volume presence), and the retailer (who can exploit long-tail economics to increase its variety of product offerings and reach specific, often niche consumers with reduced risk of dead shelf space).

Virtualized wholesaling may be able to take advantage of a wealth of information collected itself or gathered from retailers, vendors, and/or manufacturers in the form of sales, order, feedback, turnaround, and much other information to recognize and feed opportunities for retailer recommendations and relationships, and even to predict consumer demand and the ability to create, fulfill, and deliver orders in JIT fashion to meet demand. Eminently scalable, the service may enable an effectively unlimited number of manufacturers and vendors to list their products, collect orders from retailers, and make use of third parties to perform fulfillment. Accordingly, virtualized wholesaling as described herein need not be constrained by volume, warehousing, fulfillment services, or heavyweight contract concerns. Manufacturer, vendor, and retailer alike may mutually benefit from the information collected from their channels as described herein.

In addition, the data itself can be commoditized. In some embodiments, a large amount of data is gathered and/or generated for various purposes including those described herein, and its value can be extended to retailers, vendors, distributors, and the like for their own use. For example, data relating to product ordering and procurement, pricing, and demand at various times of year may be projectable and thus have value to existing retailer customers for future purchasing plans; hence, a data product can be produced from analyzing raw data for sale to the retailer customer to project or help with projecting future demand. Data products can also, in some instances, be interpreted and used to support a demand guarantee, future financial decisionmaking, pricing risk or other risk products, data products, and/or product insurance, among other things. In addition, or alternatively, the raw data itself can be prepared to be understood in a usable way, and sold even without analysis or implementing analytic software.

Throughout the description, “vendor” and “manufacturer” may be used interchangeably. The source of a product posted by the virtualized wholesaler may be the manufacturer of the product or a vendor acting on behalf of the manufacturer. In some instances, the manufacturer and the vendor are one and the same. Therefore, unless the context indicates otherwise, no distinction need be made between “vendor” and “manufacturer” to understand the disclosed concepts. Similarly, although “product” and “brand” may be used interchangeably, context may dictate a difference (such as a “brand” comprising one or more “products”). Similarly, “retailer” may be used interchangeably with “retailer customer” and represent not merely the traditional bricks-and-mortar retailer but also virtualized retailers, such as online retailers, retailers in AR/VR, and/or the like borne of technology past, present, and future without limitation. Also, “product” is understood to include the notion of a more general “product category”, such as baked goods, hardware, ingredients, dietary preferences, etc., or even categories within categories such as cookies (e.g., locally baked cookies within cookies within baked goods) or hardware (e.g., diamond-tipped drill bits within drill bits within hardware), etc.). No distinction need be drawn for the purposes of understanding the disclosed concepts unless context dictates otherwise.

In some scenarios, a product manufacturer or vendor may not have a steady business relationship or ready outlet to exploit in selling its products. For example, a vendor of a newly established or niche product may have difficulty making its product, or even its brand, known to enough retail establishments to fully participate in the market. A virtualized wholesaler may make an arrangement whereby the product may be posted online for discovery by a retailer in accordance with analysis to customize the posted product for the retailer's needs (more specifically, the needs of the retailer's customer). That arrangement may take the form of the virtualized wholesaler providing complementary applications (“apps”) to the retailer and vendor, analyzing a variety of data to reveal relationships among the data, and act on those relationships to the mutual benefit of the retailer and vendor. For example, the analysis performed by the virtualized wholesaler may reveal that a product sold by the vendor could find a buyer in the retailer's store. The retailer and vendor via their respective apps may provide some or all of that data to the virtualized wholesaler.

In some scenarios, the arrangement may help solve a vendor's dilemma: The vendor could self-distribute to retailers limited in number and size, or attempt to work with the traditional distributors using their systems and relationships established over years and unlikely to be adjusted to fit the needs of a small vendor. Taking those tasks in-house, though, might add an unwanted dimension to the vendor's business, making the vendor the manufacturer, vendor, and wholesaler. The disclosed virtualized wholesaler largely removes the wholesaling burden from the vendor and at the same time enables the vendor, via any of a variety of means, to access data, financial tools, access to financing or lines of credit, reporting, and analytics maintained by the virtualized wholesaler via a unified view with an integrated set of tools.

Certain activities on the vendor side also traditionally require substantial human involvement with concurrent skill. Demand management generally is an example. Inventory management, price management, and/or promotion/sales management may be statistically dependent variables in machine learning models for demand management. For a small vendor in particular, but also for larger vendors, a customized end-to-end tech-enabled distribution platform and product supply chain based on virtualized wholesaling as described herein provides an environment in which to grow and thrive.

Retailers have their own dilemmas, some of which may include the reality of margins as a driver for product ordering and placement. Small retailers in particular may cater primarily to regular customers who have their own unique and uniquely personal preferences and needs, and might be ideal for niche product offerings. However, while it may on occasion be possible to satisfy one customer requesting one niche product, the model may not scale due to constraints of storage space, shelf space, shelf life, and small margins. Even special requests may be unprofitable in a vacuum, and trying to satisfy multiple special requests can be so unprofitable that the small retailer may be obliged only to stock well-known brands that can be purchased from wholesale and easily stored, knowing that they will sell predictably enough for regular ordering and stocking. In turn, the wholesaler has no incentive to push niche products on the retailer because the wholesaler has its own constraints on space and the realities of supply and demand. This also reinforces the wholesaler's incumbent selection/planogram.

Virtualized wholesaling as described herein may provide retailers access to a wider number of niche products. However, this gives retailers, who are obliged to know and track products, ever more products to know and track, and ultimately to purchase and place. This is beyond the ability of the typical human buyer for retail stores—there is simply too much data that a human generally would not—and could not—know and/or remember. The disclosed virtualized wholesaling enables the retailer to proactively purchase and stock product based on data, not solely on the instincts of a human buyer. Note that the predictive analytics of the virtual wholesaler solution may take advantage of data not just for the store, but for similarly situated stores. A store in Seattle, Wash. may be similarly situated as a store in Columbus, Ohio, and the data analytics model may enable more accurate predictions as to what specific rotation of products for shelf space would maximize sales or maximize margin, for example.

In some embodiments, an advantage can be gained with a system that utilizes gathered data not just to recommend a product in response to historical demand or any specific retailer inquiry, but to determine when a particular product or product category might be successfully placed without retailer demand or inquiry. For example, the virtualized wholesaler is able to leverage its vast historical data gathered from past orders, sales, distributions, and/or other factors to reach out to a retailer with a recommendation to stock or even to introduce a particular product or product, optionally at a particular price point, size, volume, product quality, timing, and/or the like, without any request or inquiry by the retailer.

In some embodiments, for example, the datasets may drive variable pricing based, e.g., on factors such as purchase volume and frequency, prompt or even advance payment and layaway options, relationship with the vendor, recommendations of the vendor, etc. In terms of product quality, brands, individual products or product categories (including by brand or product/product category), all the way down to individual or even combinations of ingredients, are nonlimiting examples of the granularity to which quality in the form of ratings (e.g., by customer review, sales, hit rate, and/or the like) may be measured, input to models, and applied to individual brands, vendors, and/or retailers, leading to optimized operations and sales. Recommendations of retailers, brands, products, pricing, advertising, promotions etc. may drive numerous models and ultimately impact shelf placement, brand exposure to existing customers (and bringing in new customers looking for niche products), and inventory optimization (amount of warehoused or retailer-held product, deciding the retailers to which limited supplies of niche products may be offered or directed, warehouse location, and/or the like), to name some nonlimiting examples.

Datasets may be compiled with a variety of data. Some examples follow. Typically, data and datasets may be filtered by brand, vendor, and/or retailer. Datasets, and the data within them, may be combined in a variety of ways. That is, the following should not be considered to be invariable compositions:

Ordering and procurement:
purchase volume and frequency, retailer-vendor relationships
pricing, demand
country or region of origin
demand curves and predicted changes in demand
inventory

Sales environment:
historical foot traffic to a particular retailer
demographic changes in the vicinity of the retailer
current or historical road conditions
temporary closing of the retail store due to a facility infrastructure problem or the owner being away on vacation

Marketing:
form of advertising, advertising rates, catalogs, promotions
source of consumer interest (e.g., consumer behavior/tracked data may be gathered or collected using cookies and/or other technology to determine interests of the consumer based, e.g., on time spent on a page; hovering position of a cursor over a product, text, or advertisement; click-throughs; instances of returning to a page, etc.)
availability of financing

Historical Sales:
ratings, reviews, trends, hit rate, reorders
customer feedback
past orders, sales, distributions, timeliness of payment, performance of past vendor or retailer recommendations
quantity, timing, retailer location
anecdotal success of a product at similar establishments in similar or remote locations
consumer behavior/tracked data
brands sold directly to the consumer
sale dates and sale times for an individual product or for multiple products

Distribution:
stock, product size, volume, route, constraints, logistics
delivery timeliness, causes of delays

Timing:
availability of brands (including when product may become available)
vendor datasets of product availability, turnaround time, and/or other information
season of year, holidays, day of week
timeframe for peak or low demand
time in inventory at warehouse or retailer
whether product is retailer- or wholesaler-only, or may be sold direct-to-consumer

Logistics:
warehouse location
time required at each interval in the supply chain (e.g., order to vendor, transport of product from vendor to virtualized wholesaler, from wholesaler to distributor, and from distributor to retailer)
shelf placement

Product:
ingredients, allergens, packaging, product quality for individual products or product categories (including by brand or product/product category)
retailer store details, including store structure, local demographics, proximity to vehicle and/or pedestrian traffic, proximity to complementary retailers, venues, and/or ethnic neighborhoods
demand-driven products
trend analysis
new product offerings
product expiration
food safety and the ability to incorporate risk of specific SKUs based on food safety concerns and historical health outbreaks related to common ingredients

Data dependency (e.g., amount of product ordered at particular timing (time of year, time of day, proximity to weekend or holiday), available ingredients, changes in ordered amount, difference in timing (time of year, time of day, proximity to weekend or holiday), change in available ingredients)

Wildcards (difficult-to-project variables)
Weather, ingredient shortages, personal situations on the vendor side such as illness, vacation, family emergency
production constraints

Data resulting from analyzing any of the above

Some models may input datasets related to a bricks-and-mortar retailer's store structure, local demographics, proximity to vehicle and/or pedestrian traffic, proximity to complementary retailers (healthy food offerings near an exercise studio), venues (kitchen supplies near a culinary school), and/or ethnic neighborhoods (items used in seasonal celebrations from “back home”), to name a few. In some examples, recommendations may be driven by supply considerations (e.g., near an exercise studio, more healthy foods may be stocked or offered at a higher price point, using dynamic models amid changing stock and sales data). Recommendations may also be driven as a function of demand management (e.g., a product associated with an upcoming blockbuster movie or a Halloween costume associated with a current event, driven by demand). Datasets may include data from the retailer, vendor, brand, wholesaler, or other source.

The recommendation may be made in connection with or independently of any specific brand or brands (indeed, recommendations can be made without considering brands at all until the final result, optionally including brands, is made to the customer). In some embodiments, the virtualized wholesaler may determine what brand or brands to recommend after gathering, generating, and/or analyzing data, and only then recommend the brands to the retailer customer. For the virtualized wholesaler, these efforts are expertly tailored to a particular retailer's business needs, considering availability of brands, ability of brand manufacturers and/or suppliers to meet the parameters in support of the recommendation, external factors such as weather, trends, historical sales data, and/or the like. For the retailer, the virtualized wholesaler has performed all of the legwork to identify brands that fit the retailer's business needs and constraints, saving the retailer valuable time, energy and anxiety.

Virtualized wholesaling as described herein can enhance the relationship between wholesaler and retailer as well because the retailer may order any number of products, from small to large, with confidence that the product will sell based on trends in similar locations and telemetry related to past movement of product at certain price points. Further, the retailer has visibility to harness the wholesaler's analytics for judging the timing and amount of products to order, knowing that with JIT supply, the products will arrive when the retailer needs them because the wholesaler is able to stock the products before the retailer needs them. Thus, for the retailer, stocking management may be a statistically dependent variable for demand management.

In between, the virtualized wholesaler gathers information from retailers, vendors, distributors, trade publications, internally, indeed from any number of sources to generate and/or feed statistical or machine learning models including deep learning to aid in product promotion, vendor assistance, and JIT delivery to retailers. The virtualized wholesaler may guide the vendor, offering product posting with knowledge of when the product can or should be made available; promotion support by pushing product recommendations, brand recommendations, and/or recommendations for discounts (when to put a product on sale at what price) to retailers based on proj ected demand; coordinated JIT service to provide transparency as to the ordering source(s), quantities to each, how and when to be delivered, etc. Many of these wholesaling services are driven by the mobile and web apps as the control panel but also as the window into the process, even as the virtualized wholesaler may maintain some features or play some roles of a legacy wholesaler, such as intake, storing, delivery to distributor, and/or the like. The virtualized wholesaler can also package this information into a data product to sell or better serve customers directly with risk mitigation resulting from data insights.

In one sense, the virtualized wholesaler may also provide a service of disintermediating itself from the vendor-retailer relationship in that the virtualized wholesaler may promote brands, not simply to have a stable of, say, chocolate cookies, but to have a niche chocolate cookie product unique to a brand that can give the brand a leg up in comparison with the myriad chocolate cookie providers with which the brand competes. Data modeling that leads to a posting for a specific brand or to a specific retailer to try a specific brand, pushed or returned in response to a search by that retailer and all based on data gathered from the many sources, may put that brand out front in a way that helps it maximize its potential. The information that feeds the data models is not available to or not utilized by legacy wholesalers or even online retailers, who at best provide a virtual shelf for niche products and nothing more. Virtualized wholesaling as described herein, on the other hand, may connect retailers or resellers with vendors in a way that, while mutually beneficial, boosts the vendor even as the retailer can provide a better customer experience.

In some embodiments, virtualized wholesaling may include receiving from a retailer data comprised of historical sales data, raw or as a dataset, the historical sales data including at least one attribute specific to the retailer; creating a machine learning data model based at least on the dataset or a dataset comprised of the raw data; and performing a prediction of a statistically dependent variable of the attribute(s) specific to the retailer. The data model prediction may be associated with a statistical level of confidence based on datasets that comprise a critical mass of information gathered over time and the accuracy of the model over time. In some embodiments, the accuracy of the model may be based on predictions over time meeting a predetermined tolerance or precision. For example, if the prediction (dependent variable) is of a change in demand for a product and the attribute(s) (independent variables) include sales of a constituent product over a period of one week, and if the retailer sets a threshold of change in demand of five sales of the constituent product in one week before ordering the product, then an order for the product may be placed with the vendor upon the data model predicting the change in demand based on the constituent sales data and the threshold (i.e., the constituent sales data meet or exceed the threshold).

In some embodiments, the prediction of a change in demand may include a corresponding amount of product that the retailer will need by a specific date. In other embodiments, a separate data model or models may generate a prediction of the necessary amount of product based on historical data relating the predicted change in demand with the amount of the constituent components sold and/or number of constituent component sales in order to meet the required date. All predictions may be associated with respective statistical levels of confidence and may be packaged into different risk levels, risk profiles, or data products.

In some embodiments, the virtualized wholesaler may relate the predicted change in demand with the availability of the product in the quantity predicted to be ordered by the retailer and needed by a specified date. In some scenarios, the virtualized wholesaler may then place an order with the vendor and post the product on the virtualized wholesaler's website or the like, even before the retailer enters its order with the virtualized wholesaler. Because of the prediction, the virtualized wholesaler is able to anticipate the retailer's need for the product and make it available for purchase, shipping, and delivery at the time required by the retailer, all based on the dataset and data models.

In addition or alternatively, data may be gathered from multiple retailers, vendor(s), and/or third parties (such as industry data or trends). Data can also be sourced by the virtualized wholesaler's history of predictions, sales, orders, deliveries, and/or feedback. Datasets may be compiled by the virtualized wholesaler or input to models as received. Indeed, the virtualized wholesaler may be considered a distribution platform as well as a product wholesaler, matching retailers with brands by leveraging transactional procurement data. In some embodiments, the virtualized wholesaler may also be able to optimize route workflows and consolidated order fulfillment to a network of in-house or third-party logistics providers, unmanned aerial vehicles (e.g., drones), or autonomous vehicles (including driverless terrestrial vehicles) to improve efficiency.

In some embodiments, the analyzed data, and even the data models, can be commoditized. As described herein, in some embodiments the virtualized wholesaler may generate datasets from various data from previous sales and sales environment conditions. The datasets can be used to develop and train data models for use in forecasting trends, demand, manufacturing, distribution constraints, and/or the like. Then, the data models can be fed current data to produce output forecasting and recommendations to be matched with product and/or brand availability. Through feedback, the data models can also be updated or supplemented with other data models, applied in parallel or serially, to improve forecasting and recommendations. The data models themselves then may become sales products (data products) for possible sale or licensing to retailer customers (e.g., to aid with their future purchase planning), vendors (e.g., to forecast demand, ingredient or component need, and set cost-of-goods expectations), or others inside or outside the supply chain (e.g., trend analysts).

With all of these services, the virtualized wholesaler is able to connect uniquely brands and retailers using data collected from, e.g. and without limitation, retailers, vendors, and/or other sources about products, product procurement, and consumer demand (indeed the evolving competitive environment in retail), to better inform targeted sales, brand growth, and right-sizing inventory—in motion—in just-in-time fashion.

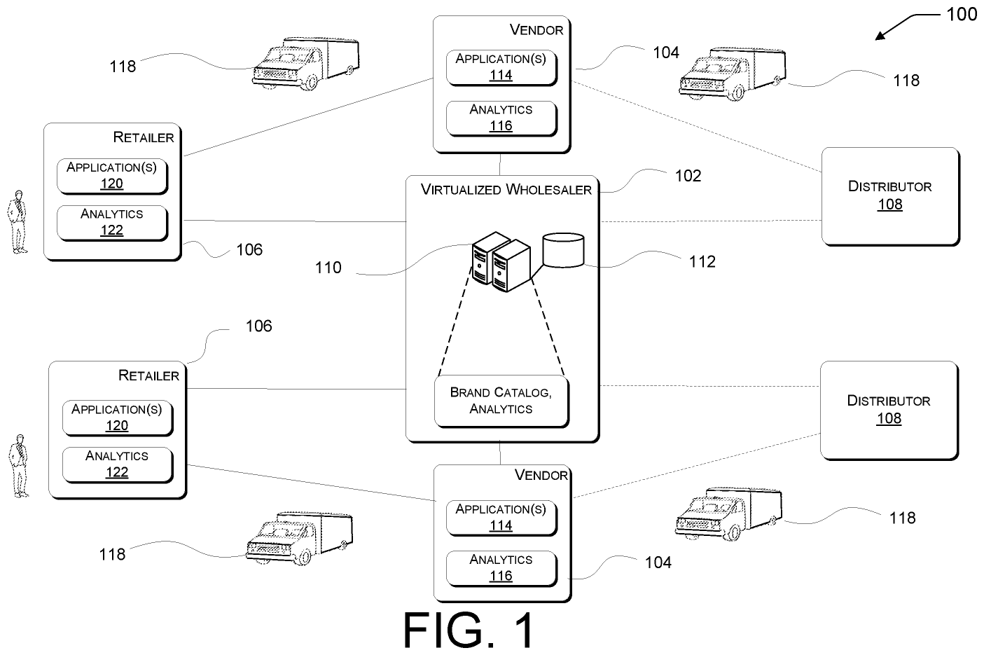

FIG. 1 illustrates an example architecture 100 for implementing a platform that matches retailers with vendors. The example architecture 100 may include a virtualized wholesaler 102, one or more vendors 104, one or more retailers 106, and one or more distributors 108.

The virtualized wholesaler 102 is generally a wholesaler for the architecture 100. The virtualized wholesaler 102 may be provided with various resources for the likes of managing product availability, handling invoicing, payments, reorders, customer service; controlling order fulfillment, and/or communicating with, and generally providing support for, the vendor(s) 104 and retailer(s) 106. Virtualized wholesaling in accordance with embodiments described herein is not limited to facilitating the brand-retailer relationship with regard to any particular product. The virtualized wholesaler 102 may be used as a hub via which retailers and vendors may coordinate orders and sales. For example, the virtualized wholesaler 102 may receive one or more orders from a retailer 106; or one or more products, or information of one or more products, from a vendor 104. The virtualized wholesaler 102 further may receive a variety of data from one or more of the retailers 106, one or more of the vendors 104, and/or one or more of the distributors 108; process and analyze the data, and in general provide services such as predictive and other analytics as described herein.

The virtualized wholesaler 102 may include one or more servers 110 and a data store 112. The server(s) 110 may include one or more network servers configured with hardware, software, and/or firmware that perform one or more of ingesting content, processing and analyzing the content, making the analysis results available for consumption, and controlling personnel and apparatus in accordance with the results, as discussed more fully below.

The data store 112 may store, for example, various data collected by the virtualized wholesaler 102, the vendor(s) 104, and/or the retailer(s) 106. The data may also have been obtained from other sources such as trade associations, municipal agencies, research organizations, and/or the like. The data store 112 may be contained within the server 110, separately but at least partially within the server 110, or externally of the server 110 as shown in FIG. 1. In some embodiments, the data store 112 may be disaggregated in, e.g., cloud storage. The data store 112 is not limited as far as the data and/or information stored therein. For example, the data store 112 may store data in raw, addressable form or in one or more databases, such as relational databases.

In some embodiments, the vendor(s) 104 may have or have access to one or more application(s) 114. The application(s) 114 may be configured to facilitate or perform a variety of operations, including but not limited to managing orders and inventory via a dashboard, thereby providing visibility into each step of the process from order to fulfillment with customizable granularity; optimizing growth (production, marketing, inventory, etc.) using real-time data and analytics provided by the virtualized wholesaler 102; and optimizing ordering, logistics, and consolidated deliveries by operation from a single source. Examples of real-time data and analytics may include analyzing historical data of purchases, deliveries, trends, and the like collected themselves or obtained from the retailer(s) 106, the virtualized wholesaler 102, or another source.

In some embodiments, the vendor(s) 104 may be goods producers or procurers. As procurers, the vendor(s) may, in some embodiments, control production of the goods (products) by other parties. The application(s) 116 may comprise hardware, software, and/or firmware, software and firmware being executable by one or more processors of computing device(s) implemented by the vendor(s) 104 in some embodiments. In these or other embodiments, products that are produced or obtained by the vendor(s) 104 may be delivered to the retailers 106 or other entities via a delivery vehicle 118 such as, without limitation, a truck as shown, a drone, or another vehicle. In some examples, deliveries may be made on foot.

The retailer(s) 106 may be physical (so-called “bricks-and-mortar”) stores, in some embodiments. A reseller (e.g., one that obtains products from a virtualized wholesaler for resale to a retailer) may be regarded as a retailer for the purposes of this disclosure. The retailer(s) 106 may have or have access to one or more application(s) 120 configured to perform or facilitate operations that may include, without limitation, product management (e.g., ordering, inventory, payment, and/or delivery) via a dashboard; optimizing in-store sales using real-time data and analytics provided by the virtualized wholesaler 102; and/or sourcing products from one source (e.g., the virtual wholesaler 102) regardless of Vendor or reseller.Product management may include receiving product offerings, managing pricing and promotions in real time, placing orders, and/or controlling payments, in some instances using real-time analytics 122, for example, by analyzing historical data of purchases, deliveries, trends, and the like collected themselves or obtained from the vendor(s) 104, the virtualized wholesaler 102, and/or another source. The application(s) 122 may comprise hardware, software, and/or firmware, software and firmware being executable by one or more processors of computing device(s) implemented by the retailer(s) 104 in some embodiments.

The distributor(s) 108 may be one or more entities that receive orders from, e.g., the vendor(s) 104 and/or the virtualized wholesaler 102 for delivery of products, typically to the retailer(s) 106 as directed by the vendor(s) 104 and/or by the virtualized wholesaler 102 via the delivery trucks 118 or other examples as outlined elsewhere herein. In some examples, the distributor(s) 108 may deliver the ordered products to the vendor(s) 104 or another entity rather than directly to the retailer(s) 106. In some examples, the vendor(s) 104 may be the distributors of products, including products produced by the vendor(s) themselves.

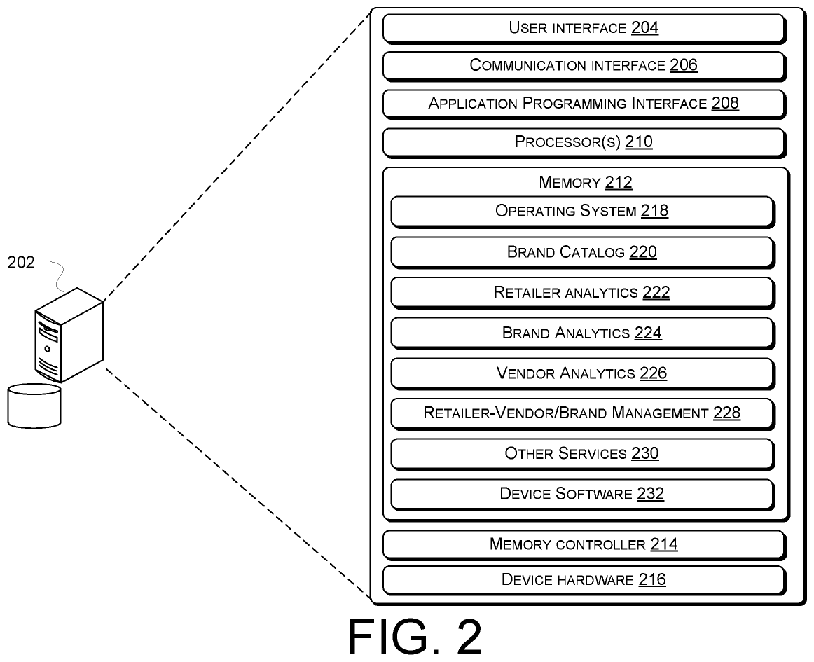

FIG. 2 illustrates various components of a server 202 that implements virtualized wholesaling. The server 202 may be configured with hardware, software, and/or firmware to, among other operations, communicate with the vendor(s) 104, retailer(s) 106, and distributor(s) 108; enable the vendor(s) 104 to list their products, collect orders from the retailer(s) 106, and make use of third parties to fulfill those orders; provide the retailer(s) 106 with easy access to a variety of products including newly established products or niche products; gather data and perform predictive analytics on the data, enabling the retailer(s) 106 to proactively purchase and/or stock product based on data and not the instincts of a human buyer, making available data that a human generally would not—and could not—know. The server 202 may represent and correspond to the server(s) 110 of the virtualized wholesaler 102 illustrated in FIG. 1, and in the nonlimiting example shown includes a user interface 204, a communication interface 206, an application programming interface 208, one or more processors 210, memory 212, a memory controller 214, and device hardware 216.

The user interface 204 may enable a user to provide input and receive output from one or more of the vendor(s) 104, the retailer(s) 106, and the distributor(s) 108. The user interface 204 may include a data output device (e.g., visual display, audio speakers), and one or more data input devices. The data input devices may include, but are not limited to, combinations of one or more of touch screens, physical buttons, cameras, fingerprint readers, keypads, keyboards, mouse devices, microphones, speech recognition packages, and any other suitable devices or other electronic/software selection methods.

The communication interface 206 may include wireless and/or wired communication components that enable the server 202 to transmit data to and receive data from other networked devices via the communication network. In some embodiments, the communication network may be a wired and/or wireless communication network, including but not limited to cellular networks, the Internet, and/or other public and private networks, including LANs, WANs, VPNs, and/or other networks internal to the virtualized wholesaler 102

The application programming interface (API) 208 may enable communications between the server 202 and one or more of the vendor(s) 104, retailer(s) 106, and distributor(s) 108 over the communication network via the communication interface 206. The API 208 may, among other features, define the format of data and instructions received and sent by the virtualized wholesaler 102, abstracting other components of the server 202 and internal layers of the server 202 in general, and extend functionality without exposing objects and services absent pre-existing permissions.

The processor(s) 210 and the memory 212 may implement an operating system 218 stored in the memory 212. The operating system 218 may include components that enable the server 202 to receive and transmit data via various interfaces (e.g., the user interface 204, the communication interface 206, and/or memory input/output devices), as well as process data using the processor(s) 210 to generate output. The operating system 218 may include a display component that presents output (e.g., display data on an electronic display, store the data in memory, transmit the data to another electronic device, etc.). Additionally, the operating system 218 may include other components that perform various additional functions generally associated with an operating system.

The memory 212 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, Random-Access Memory (RAM), Dynamic Random-Access Memory (DRAM), Read-Only Memory (ROM), Electrically Erasable Programable Read-Only Memory (EEPROM), flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. Computer readable storage media do not consist of, and are not formed exclusively by, modulated data signals, such as a carrier wave. In contrast, communication media may embody computer-readable instructions, data structures, program modules, or other data in a modulated data signal, such as a carrier wave, or other transmission mechanism.

The memory controller 214 may include hardware, software, or a combination thereof, that enables the memory 212 to interact with the communication interface 206, processor(s) 210, and other components of the server 202. For example, the memory controller 214 may receive data or instructions from the communication interface 206 and store the same in the memory 212, and/or send the received data or instructions to the data store 112. In some embodiments, the memory controller 214 may retrieve instructions from memory 212 for execution by the processor(s) 210.

The device hardware 216 may include additional hardware that facilitates various device functions performed by the server 202.

The memory 212 may, in addition to the operating system 218, store various software such as, without limitation, a brand catalog 220, retailer analytics 222, brand analytics 224, vendor analytics 226, a retailer-vendor/brand management module 228, other services 230, and device software 232. The software may include computer-executable instructions that, if executed by the processor(s) 210, cause the processor(s) 210 to perform various operations.

The brand catalog 220 may be storage for product information, and in particular for information on products available from individual vendor(s) 106. In this sense, the brand catalog 220 may represent a virtual catalog of products for each vendor, whether the vendor be the brand, a manufacturer of the brand, or any other breakdown associated with the product. In some examples, a brand manufacturer as a vendor may have its products managed by the virtualized wholesaler 102 in the brand catalog 220 so that products can be posted for viewing and/or ordering by a retailer 104. The products may be organized to be retrievable by product name, brand name, or any suitable search query, and managed accordingly. The brand catalog 220 for any particular brand or vendor may include products or brands not currently posted for the retailer 104, and may instead be posted in accordance with specific requests or in accordance with chosen search terms, filters/tags, order history, or predictive analytics as discussed elsewhere herein.

The retailer analytics 222 may comprise computer software, firmware, or hardware, of a combination of these, and may analyze data including, without limitation, purchase and sales data, order data, delivery data, customer feedback, trend analysis, supply data, catalogs, and the like, and/or data resulting from analyzing any of these, compiled by or on behalf of retailers 106 individually. The one or more processors 210 may implement the retailer analytics 222. The retailer analytics 222 may be configured to train the models using the various data and machine learning. The models may be configured to receive some or all of the various data mentioned herein, and output data indicating one or more recommendations for the retailer to carry out.

The retailer analytics 222 may analyze aspects of retailers on an individual basis with any desired granularity. For example, the retailer analytics 222 may derive correlations between and among data points in the analyzed data to be added to one or more machine learning data models created and/or implemented by the retailer-vendor/brand management module 228. In other embodiments, the retailer analytics 222 may use a rule-based scheme.

In some embodiments, the retailer analytics 222 may process this data related to the retailer using various rules and/or machine learning models. The rules may specify how to compare the various data fields and output data indicating an action to be taken by or on behalf of the retailer. For example, and without limitation, the models may be configured to input data related to purchase and sales data, customer feedback, trend analysis, and supply data and output a confidence score that a particular action, such as increasing the price of a specific niche item, will result in increased profit on sales of the item in view of predicted demand vs. predicted supply of the item. In this way, machine learning may be employed to predict both supply and demand, for brand to retailer (e.g., promotional materials, when to put an item on sale or offer a discount, bundle two or more items (e.g., tie sales of popcorn to movie tickets to a nearby theater, a picnic basket to plastic flatware, peanut butter to chocolate, root beer to ice), and/or the timing of these, to name a few).

In some embodiments, the confidence score may reflect the likelihood that the retailer analytics 222 may determine a likelihood that the action will succeed using the models and/or the rules. For example, a confidence score of 0.8 on a 1 point scale may indicate an eighty percent chance that action will have the desired result (in this example, increased profit on sales of the specific niche item). A confidence score of 0.4 may indicate a forty percent chance of the same.

Based on the output of the rules and/or the models, the retailer analytics 222 may determine whether to recommend the indicated action. In instances where the output of the model is a recommendation with a confidence score that exceeds a preset threshold (i.e., the recommendation is strongly indicated by the model), the retailer analytics 222 may provide a notification to the retailer (if the virtualized wholesaler grants the permission) or to the virtualized wholesaler (if the virtualized wholesaler maintains control over providing the notification, for example if the retailer is not current with its account, or for any other reason, which may be hardwired into the rules). In some embodiments, the retailer analytics may recommend more than action for the retailer, and/or automatically take the action(s).

The models may be configured to receive a preconfigured dataset that includes data in categories considered to impact the desired prediction. In some examples, the models may be trained using machine learning and historical data. The retailer analytics 222 may include computer-executable instructions written to select a model based on the received data. For example, the retailer analytics 222 may retrieve purchase and sales data, order data, customer feedback, trend analysis, and supply data for a retailer and select a model that is configured to receive those types of data (e.g., a model that has been trained to input such data and output a prediction for that retailer). The retailer analytics 222 may provide the data to the selected model, which outputs the data indicating the likelihood that the recommended action will succeed.

The brand analytics 224 may analyze data including, without limitation, purchase and sales data, order data, delivery data, customer feedback, trend analysis, supply data, catalogs, and the like, and/or data resulting from analyzing any of these, compiled by or on behalf of brands individually. The brand analytics 224 may analyze aspects of brands on an individual basis with any desired granularity. For example, the brand analytics 224 may derive correlations between and among data points in the analyzed data to be added to one or more machine learning data models created and/or implemented by the retailer-vendor/brand management module 228. Such models may be trained and implemented in a manner similar to that described with respect to the retailer analytics 222, using data tailored to brand-relevant data.

The vendor analytics 226 may analyze data including, without limitation, purchase and sales data, order data, delivery data, customer feedback, trend analysis, supply data, catalogs, and the like, and/or data resulting from analyzing any of these, compiled by or on behalf of vendors 104 individually. In some embodiments, one or more of the vendors 104 may be the brand producers and/or sellers themselves. The vendor analytics 226 may analyze aspects of the vendors 104 on an individual basis with any desired granularity, such as per product, per SKU, and/or the like. In some embodiments, the virtualized wholesaler may integrate with point of sale systems and providers, even more refinement can be achieved around data for specific transactions, SKU placements, and other factors incorporated as inputs into a model, with or without comparing to wholesale procurement and reorder rates. This type of model can also consider these factors and how they relate to rate of product sale (such as how quickly the product sells when it appears on the shelf, or how fast inventory is depleted in general) at specific price points and locations in the store or locations of the store itself In some examples, the vendor analytics 226 may derive correlations between and among data points in the analyzed data to be added to one or more machine learning data models created and/or implemented by the retailer-vendor/brand management module 228. Such models may be trained and implemented in a manner similar to that described with respect to the retailer analytics 222, using data tailored to vendor-relevant data.

The retailer-vendor/brand management module 228 may include one or more data models and/or machine learning modules for training the data models using datasets derived from data provided by the vendor(s) 104, retailer(s) 106, distributor(s) 108, and/or other sources, including data created, collected, or held by the virtualized wholesaler 102 itself. In some examples, the training dataset may be data compiled for an individual brand. The data may, for example, include data as independent variables (e.g., time of year or cost of goods sold data) and data as dependent variables (e.g., gross sales or sales by location). One or more data models may be chained so that values of dependent variables output by one data model may be fed as independent variables to a subsequent data model. Such models may be trained and implemented in a manner similar to that described with respect to the retailer analytics 222, using data tailored to these relationships. The data may be internal data including, but not limited to, any of the data gathered, analyzed, generated, compiled, and/or collected by one or more of the vendor(s) 104, retailer(s) 106, distributor(s) 108, the virtualized wholesaler 102, or by any other source(s).

In making the vendor's products visible to retailers, the retailer-vendor/brand management module 228 may utilize machine learning modules to determine, or predict, specific brands of a product manufactured and/or sold by the vendor. For example, the retailer-vendor/brand management module 228 may develop data models that input retailer datasets of inventory, sales, and/or other information; brand datasets of new product offerings, production constraints, and/or supply chain considerations; vendor datasets of product availability, turnaround time, and/or other information; and/or virtualized wholesaler datasets of stock, product expiration, retailer, brand, vendor, and/or product analytics, and output predictions of newly established products or niche products that may sell within a specified time period. In some embodiments, the retailer-vendor/brand management module 228 may utilize machine learning modules that train one or more data models using initial datasets and results of inputting specific independent variables to any level of granularity desired (e.g., time of year; day of week; proximity to business environments, entertainment establishments, or neighborhoods; type of packaging; location demographics, and so on), deriving a prediction of various product sales from the data model(s), and output the prediction (more specifically, one or more dependent variables such as sale of a specific product, number of sales, timing of sales, and/or the like) with an associated statistical confidence level. The statistical confidence level may be required to meet or exceed a threshold, which may be predetermined for one or more of the dependent variables, in order for the output values to be considered reliable and thus implemented in the virtualized wholesaler's decisionmaking.

The datasets that feed both training and running of trained models are vast in number. Virtually all data gathered by the various systems described herein are ripe for mining. To the objective of growing a retailer's customer base, tracking local purchasing trends and national purchasing trends develops data regarding numbers of sales regarding certain products, categories of products, and sub-categories of products without granular constraints—gluten-free, new grains, diet trends, etc.

In some embodiments, deciding to recommend or directly list products (e.g., vegan cookies, environmentally friendly paint, pH-balanced pet shampoo, XYZ Winery merlot, etc.) may make the products visible directly to retailers whether or not the retailers 106 specifically request a product, category of product, or any other request via its application 120. In addition, or in the alternative, the virtualized wholesaler 102 may push product recommendations to the retailer(s) 106 based on outputs of the data model, without the retailer realizing the benefit of carrying such products. Beyond allowing retailers 106 visibility into the products, vendors 104 may also have improved visibility into the exposure of their products and interest in their products, including but not limited to sales made to any number of individual retailers 106 (even if not via the virtualized wholesaler 102), the feedback of which may be added to the dataset(s) and result in the products becoming used in the virtual wholesaler solution's data models. In some embodiments, sales to one or more retailers 106 added to the dataset(s) and run on the data model(s) may result in the virtualized wholesaler 102 surfacing the product to other retailers 106, based at least in part on the sales of the product to such retailer(s), thereby aiding in the growth of the product or brand and, in turn, its manufacturer.

Data modeling may also include performing a prediction of a change in a variable that is statistically dependent on the predicted demand. For example, the virtualized wholesaler 102 may receive from a retailer 106 a dataset, or data to be added to a dataset, relating to historical sales that includes at least one attribute (e.g., a statistically independent variable) specific to the retailer 106. The data, alone or aggregated with historical data in the dataset (which may include data from other retailers), may be partitioned into data partitions based on the at least one attribute specific to the retailer 106. In this example, the virtualized wholesaler 102 may create a machine learning data model based at least on a data partition from the dataset to output a prediction of a change in the attribute as a statistically dependent variable specific to the retailer 106.

In some embodiments, the output or outputs of the data model(s) enable the virtualized wholesales 102 to enhance the relationship between the retailer and vendor to the extent that the models are tuned to output information for logistics to ensure JIT delivery to the retailer(s) 106, whether or not the retailer has requested a specific delivery or even, in some instances, whether or not the retailer has even yet placed an order. The retailer may order any number of products, from small to large, with confidence that the product will arrive timely and sell. Further, the retailer has visibility via its app to harness the wholesaler's analytics for judging the timing and amount of products to order, knowing that with JIT supply, the products will arrive when the retailer needs them because the wholesaler is able to stock the products when the retailer needs them. Thus, for the retailer, stocking management may be a statistically dependent variable for demand management. Concomitantly, with the information gathered from retailers, vendors, distributors, trade publications, internally, indeed from any number of sources to generate and/or feed machine learning models to aid in product promotion, vendor assistance, and JIT delivery to retailers, the virtualized wholesaler 102 may guide the vendor, offering product posting with knowledge of when the product can or should be made available; promotion support by pushing product or product category recommendations to retailers based on projected demand; coordinated JIT service to provide transparency as to the ordering source(s), quantities to each, how and when to be delivered, etc.

Other services 230 may include wholesale workflow management services such as product intake, storage, and shipping, and coordinating the same; payment, financing, collection and fulfillment of orders (optionally by leveraging third parties); third-party applications; dataset integration; and/or other services associated with product wholesaling, especially those tailored to JIT delivery of products to the retailer(s) 106. In this regard, JIT servicing is not simply about logistics; the disclosed virtualized wholesaling can ensure that the wholesaler has the product in stock so that the retailer has the product in stock when the retailer needs it, fueled by predictive analytics and working the supply chain accordingly.

Financing may be implemented for the benefit of the vendor, and may take the form of increased fees for the virtualized wholesaling, a larger portion of revenue generated from sales, and/or the like. Alternatively, financing may take the form of a conventional loan or a virtualized wholesaler-branded credit card. As in many of the transactions and interactions outlined herein, financing offers another data source that can feed modeling, also as described herein, for added accuracy in modeling, prediction, and recommendation, for the benefit of the vendor, its retailers, and other vendors and retailers in the form of increased sales and satisfied consumers, all for which the data may be evaluated.

The device software 232 may include software components that enable the server 202 to perform typical server functions. For example, the device software 232 may include a basic input/output system (BIOS), Boot ROM, or bootloader that boots up the server 202 and executes the operating system 218 following power up of the server.

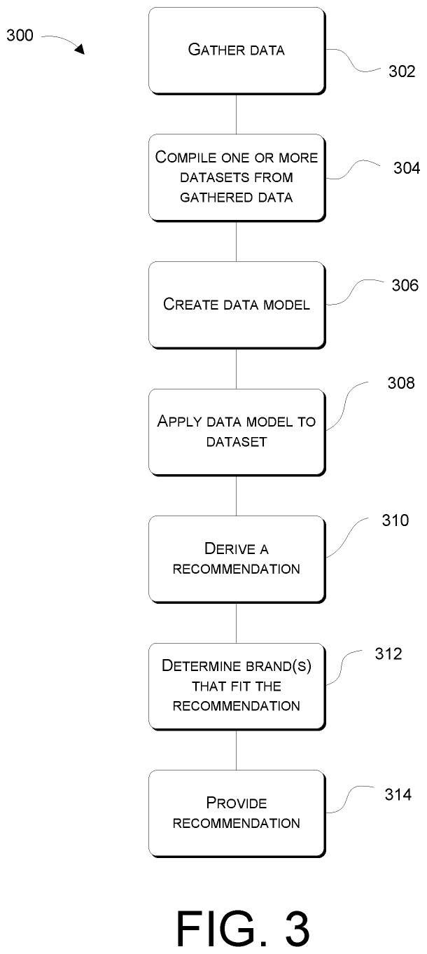

FIGS. 3-5 present illustrative processes 300, 400, and 500, respectively, for implementing virtualized wholesaling. Each of the processes 300, 400, and 500 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300 and 400 are described with reference to the architecture 100 of FIG. 1.

FIG. 3 is a flow diagram of an example process 300 performed at least in part by the server 202 for implementing product and/or brand recommendations to a retailer. In some embodiments, the process 300 may output a simple brand recommendation as a result of brand-agnostic computations to first reach a product or product category recommendation, and then to determine a brand or brands that meet parameters that fit a particular retailer's needs.

At block 302, the server 202 may gather data from one or more retailers, vendors, distributors, trade publications, weather reports, news publications, and/or the like. The number and type of sources are practically unlimited. The gathered data may include data compiled by or already housed by the virtualized wholesaler, for example from its own prior research and/or business activity. The data may be of any sort (for example raw or processed, structured or unstructured, etc.) and categorizable a practically unlimited number of ways.

At block 304, the server 202 may compile one or more datasets from the gathered data. In some embodiments, one or more of the datasets may be useful as training datasets to train machine-learning data models as described elsewhere herein. A dataset may comprise data of a particular retailer, brand, product, product category, and/or the like such that, if fed into an appropriate data model will produce an output that either indicates a desired result or can be used to find a desired result. For example, a chosen dataset may contain data relevant to making product recommendations for a retailer.

At block 306, the server 202 may create a data model for providing a result (a dependent variable such as a recommended product) based on input of one of the datasets (comprising one or more independent variables such as season of the year, neighborhood of a retailer, and/or the like). The data model can be created by finding a best fit algorithm for a chosen dataset (known as a “training dataset”) and then adjusting the algorithm until the output is within a threshold of satisfaction. In some scenarios, the data model may be a product itself, to be potentially sold or licensed for use by a retailer, analyst, or other to find a result based on its own data input.

At block 308, the server 202 may apply the data model to one of the datasets. This dataset typically includes data points chosen as independent variables deemed to inform a reliable result to whatever end the data model was created. Some examples of the data model may have been developed to determine a timeframe for peak demand of a certain product based on historical foot traffic to a particular retailer and trend data gathered by the virtual wholesaler, or to determine a product to be recommended to a retailer based on demographic changes in the vicinity of the retailer combined with a current surge in US-made products of a similar type. In some embodiments, the types of data model are limited only by the needs identified by the virtualized wholesaler and the number of data models is practically limitless.

At block 310, the server 202 may derive a recommendation from the data model output. The recommendation may be of a product, product category, or brand, for example. In some embodiments, the recommendation may be “realized” or “recognized” by the data model, or by a person interpreting the output of the data model in conjunction with other information not fed to the data model (such as current road conditions, temporary closing of the retail store due to a facility infrastructure problem or the owner being away on vacation, anecdotal success of a product at similar establishments in similar remote locations, and so on), without input from the retailer other then any data included in the dataset. The recommendation may be brand-agnostic (vegan cookies) and/or nonspecific (fresh fruit).

At block 312, the server 202 may determine a brand or brands that fit the recommendation. For example, the data model may output a recommendation for a particular retailer to stock vegan cookies and, with constraints of shelf space, cost of ingredients, foot traffic at the retailer, and/or other factors, the server 202 may take the determination and be able to identify one or more brands recorded in a database that meet all criteria. In some embodiments, these results may be informed or filtered by human input. Accordingly, the recommendation may be for a particular brand of a particular product for a particular retailer to stock at a particular time.

At block 314, the server 202 may provide the recommendation to the retailer. In some embodiments, the recommendation may be a particular brand, surfaced via an app viewable by the retailer, who may have no knowledge of the analysis that went into making the recommendation, or even know that a recommendation was forthcoming. The recommendation may take any suitable form, such as a picture of the product and hyperlink to place the order, and may be accompanied by other recommendations such as when to stock

In some embodiments, the analyzed data, and even the data models, can be commoditized. As described herein, in some embodiments the virtualized wholesaler may generate datasets from various data from previous sales and sales environment conditions. The datasets can be used to develop and train data models for use in forecasting trends, demand, manufacturing, distribution constraints, and/or the like. Then, the data models can be fed current data to produce output forecasting and recommendations, to be matched with product and/or brand availability or to place orders on the retailer's behalf automatically, for example. Through feedback, the data models can also be updated or supplemented with other data models, applied in parallel or serially, to improve forecasting and recommendations. The data models themselves then may become sales products (data products) for possible sale or licensing to retailer customers (e.g., to aid with their future purchase planning), vendors (e.g., to forecast demand, ingredient or component need, and set cost-of-goods expectations), or others inside or outside the supply chain (e.g., trend analysts). Similarly, the datasets run through the data models may be data products. Other data products may include raw data underlying the datasets, analyzed and/or interpreted data model output, advanced data analytics, and/or a planogram to help the retailer optimize shelf space and presentation given a known strategic direction, test strategies in the store (such as, and without limitation, introducing a luxury product with a staple product in the same category in the same or different placement).

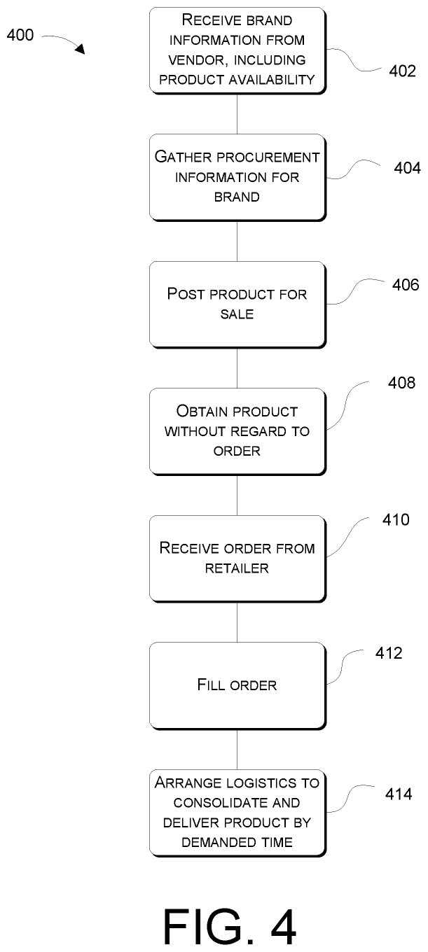

FIG. 4 is a flow diagram of an example process 400 performed at least in part by the server 202 for implementing virtualized wholesaling of a vendor's product offerings. In some embodiments, the process 400 may be brand-specific, i.e., performed on behalf of a brand to provide transparency in JIT wholesaling support for the brand.

At block 402, the server 202 may receive brand information from a vendor 104. The brand information may include, for a product, one or more of brand name, quantity or size, date of production, date available for delivery to the virtualized wholesaler 102 or to a retailer 104, expiration date, and/or the like. In this context, “brand” may refer to a product manufacturer, procurer, provider, or a product itself. In some examples, the brand may be a product that is not regularly stocked by the virtualized wholesaler 102, such as a niche product like craft cookies from a singular kitchen or bath salts of a unique blend of ingredients.

At block 404, the server 202 may gather procurement information for the brand. Procurement information may include recent and historical information regarding retail orders (e.g., quantity, timing, retailer location), time required at each interval in the supply chain (e.g., order to vendor, transport of product from vendor to virtualized wholesaler, from wholesaler to distributor, and from distributor to retailer), wildcards (difficult-to-project variables such as weather, ingredient shortages, personal situations on the vendor side such as illness, vacation, family emergency), and the like that inform the overall process of procuring products for JIT stocking. Procurement information may include data collected by the virtualized wholesaler 102 as well as data gathered from the vendor(s) 104, retailer(s) 106, distributor(s) 108, and/or other sources.

At block 406, the server 202 may post a product for order. In some embodiments, posting the product may involve predictive analytics that feed the JIT process, including timing the order for production, receiving the product for stocking, and sending the product out for delivery to the retailer 106 for placement on the shelf. The JIT process aims to reduce to the extent possible the time at the virtualized wholesaler 102, time on the shelf, and transit time from vendor to retailer. Thus, it can be said that the retailer's store is optimized for consumer demand as the predictive analytics incorporate demand forecasting as well as supply forecasting, and also may, in some embodiments, incorporate consumer or partner feedback regarding factors such as packaging attributes, shipping concerns, and the like. Feedback may be direct feedback to the data model(s) for fine-tuning, or may be expressed in output reports to be distributed, e.g., for human review. Such reports may aid with sales and trend analysis as well as to monitor the quality of the predictive outputs.

At block 408, the server 202 may obtain the product from the vendor 104 regardless of whether a retailer 106 placed an order. By utilizing the predictive analytics with machine learning, the virtualized wholesaler 102 is able, with a statistical confidence, place an order for a particular product by a particular brand, however niche, and have it delivered to a retailer 106 in JIT fashion with the goal of reducing the product's shelf time to the greatest extent possible. In some embodiments, this will entail systemic knowledge of factors such as time of consumer demand at a particular store, knowledge of a vendor's ability to produce the product and how quickly, and knowledge of logistical factors such as distributor availability, transit conditions, etc.

At block 410, the server 202 may receive an order from a retailer 106 for the product. In some embodiments, the order is received from the retailer after the virtualized wholesaler 102 has placed the order with the vendor. Using the predictive analytics, the virtualized wholesaler 102 is able to project with a statistical confidence the likelihood that the product in question will be ordered with a particular delivery date/time requested, and so place the order with the vendor 104 sufficiently ahead of the time for delivery to the retailer 106. Likewise, with transparency into the needs of the retailer 106, the vendor 104 is able to use its own predictive analytics to ensure that the necessary ingredients, packaging, staffing, etc. are in place to create the product in time to meet the anticipated order.

At block 412, the server 202 may fill the order for sending to the distributor 108. In this regard, the order may be actually filled (e.g., received, offloaded, counted, marked, stocked, removed from stock, marked for sending, loaded, and sent) by personnel, robotics, or a combination of the two, with the server 202 having control over one or more functions related to the order fulfillment.

At block 414, the server 202 may arrange the logistics of sending the product to a distributor 108 and delivering the product to the retailer 106. The logistics may include, without limitation, consolidating orders for the same retailer 106 so that the delivery of multiple, unrelated orders are fulfilled and delivered at once while honoring the JIT objective to the extent possible. Although the JIT objective is a considerable feature, it is noted that some retailers insist on, or at least favor, consolidated deliveries so as to reduce the staffing, complexity, and inconvenience of receiving multiple truck deliveries at the same time or throughout the day. By contrast, as described herein enables even niche products to enjoy the advantages of consolidated delivery, including but not limited to making available a larger variety of retailers from small businesses to large, even global, enterprises.

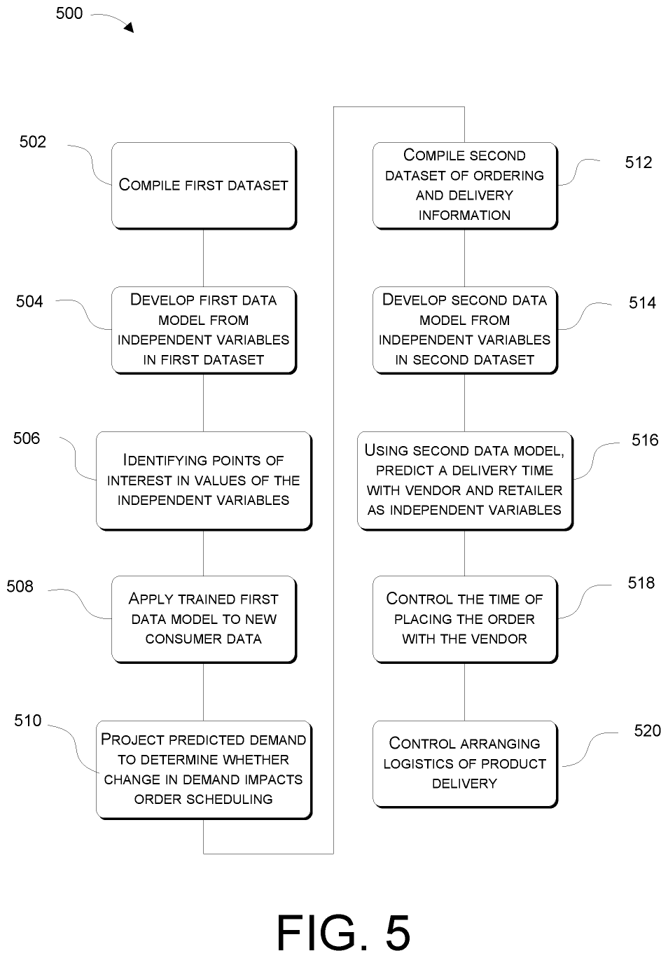

FIG. 5 is a flow diagram of an example process 500 performed at least in part by the server 202 for implementing predictive analytics and machine learning, with the goal of delivering a product to a retailer 106 as nearly as possible to a projected need date, thereby reducing if not minimizing time on the shelf or in store inventory. As is the case with respect to the process 400, in some embodiments, the process 500 may be brand-specific, i.e., performed on behalf of a brand to provide transparency in JIT wholesaling support for the brand. Further, machine learning is but one example of predictive modeling that may be implemented. Indeed, at least some of the embodiments described herein may be carried out using different techniques which may include, but are not limited to, statistical modeling without learning, rules-based action, and others.

At block 502, the server 202 may compile a dataset for input to a data model. The dataset may comprise historical retail sales data of various products, consumer behavior/tracked data, and/or brand-specific e-commerce data for brands sold directly to the consumer, to include values of one or more independent variables specific to an identifiable first retailer. The historical retail sales data may include sale dates and sale times for an individual product or for multiple products. The consumer behavior/tracked data may be gathered or collected using cookies and/or other technology to determine interests of the consumer based, e.g., on time spent on a page; hovering position of a cursor over a product, text, or advertisement; click-throughs; instances of returning to a page, etc. Brand-specific e-commerce data for brands sold directly to the consumer may be gathered or collected from any of a variety of third-party sources including trade publications, brand manufacturers, or from the virtualized wholesaler's own data, including data derived from point-of-sale, e-commerce, and other purchases, and/or other store or brand data, to augment the virtualized wholesaler's platform data. In some embodiments, the dataset may be compiled from retail sales information provided by, e.g., any combination of the vendor(s) 104, retailer(s) 106, and/or other sources, including data retained by the virtualized wholesaler itself

At block 504, the server 202 may develop a data model using data from the dataset as one or more independent variables. In some embodiments, the data model may be a trained machine language (ML) data model trained from the dataset, and predicts a change in demand for the product based on the values of the one or more independent variables in the first dataset. For example, and without limitation, independent variables chosen for predicting Brand P chocolate cookie sales may be season of the year, trending sales in sugar-free cookies, and sales during school hours and outside of school hours. In another example, independent variables chosen for predicting sales of Brand E bath salts may be recent sales of scented candles and streaming movies.

At block 506, the data model may be trained using temporal data. In some embodiments, one or more points of interest in the values of the independent variables related to changes in demand for the first product may be identified. For example, and without limitation, sharp changes in recent sales of sugar-free cookies may coincide with a drop in orders for chocolate cookies by Brand P. If the model does not reflect the coincidence accurately (e.g., if the model predicts movement in the dependent variable of sales lag to order with an accuracy that fails to reach a threshold), training will continue until the model consistently reaches the threshold, in turn achieving a minimum statistical confidence.

At block 508, the server 202 may apply the data model to new consumer data corresponding to the independent variables. In some embodiments, applying the data model may include performing a prediction of demand for the product based on the identified one or more points of interest. In some instances, the data model may be applied to consumer data gathered from a specific retailer 106 with respect to a product of a specific brand (e.g., Brand P chocolate cookies).

At block 510, the server 202 may project the predicted demand to determine whether a change in demand may impact a schedule of ordering the product from the vendor 104 to meet the ensuing need of the retailer 106. For example, the product may be trending in similar locations suggesting a change in demand, tied to or in addition to how quickly the product will move on and off the shelf at certain price points. Projecting how quickly the product will move off the shelf can be predicted with specific degrees of certainty in accordance with a properly trained data model as described elsewhere herein. In some embodiments, a change in demand may call for a delay in ordering, e.g., the Brand P chocolate cookies from the retailer 106 in order to meet a JIT demand.

At block 512, the server 202 may compile, from ordering and delivery information of past orders from the retailer(s) 106 for the product from the vendor 104 using the distributor(s) 108, a second dataset comprised of, e.g., historical ordering and receiving data for the vendor 104, historical delivery data of that product from the vendor 104 to various retailer(s) 106, and values of one or more independent variables specific to the vendor and the retailer. In some embodiments, the historical ordering, receiving, and delivery data may include the success of meeting requested or proj ected times of delivery of the product to the retailer. The data also, or alternatively, may include data from other, similarly situated vendor(s) and/or retailers for similar products.

At block 514, the server 202 may develop a trained second data model from one or more independent variables in the second dataset that predicts an optimized delta between expected delivery time and actual delivery time of the first product to the first retailer. In some embodiments, An optimized delta corresponds to a delivery that most closely meets the expected or requested delivery time; predicting the optimized delta thus predicts how close the supply chain may come to meeting the expected delivery time. In some embodiments, the independent variables fed into the second data model may include, without limitation, amount of product ordered, timing (time of year, time of day, proximity to weekend or holiday), available ingredients, and/or the like. Thus, the prediction may be made without regard to the time of any particular order to be delivered, meaning that the prediction is based on other factors such as, and without limitation, changes in ordered amount, difference in timing (time of year, time of day, proximity to weekend or holiday), change in available ingredients, and/or the like.

At block 516, the server 202 may, using the second data model, predict a delivery time of the product to the retailer 106 based on the vendor 104 and the retailer 106 as independent variables. Various other independent variables may be selected in addition or in the alternative. However, if the second data model is trained to a high degree of statistical confidence, the second data model would be expected to output a delivery time that can be relied upon to be correspondingly accurate.

At block 518, the server 202 may control the time of placing the order with the vendor 104 on behalf of the retailer 106 in accordance with the prediction of the first data model based on the change in demand meeting the point of interest. In some embodiments, the server 202 may receive a direct order from the retailer 106 for the product, and place the order with the vendor 104 in response to the retailer's order and in accordance with the JIT needs of the retailer 106. In other embodiments, the server 202 may place the order with the vendor 104 in advance of receiving the order from the retailer 106, or even without receiving such an order, in accordance with a business arrangement and predictive metrics described elsewhere herein.

At block 520, the server 202 may control arranging the logistics of product delivery to the retailer 106. The logistics may include, without limitation, the choice of supplier (e.g., distributor) of the product suited to meeting the prediction of the second ML data model and the time of ordering.

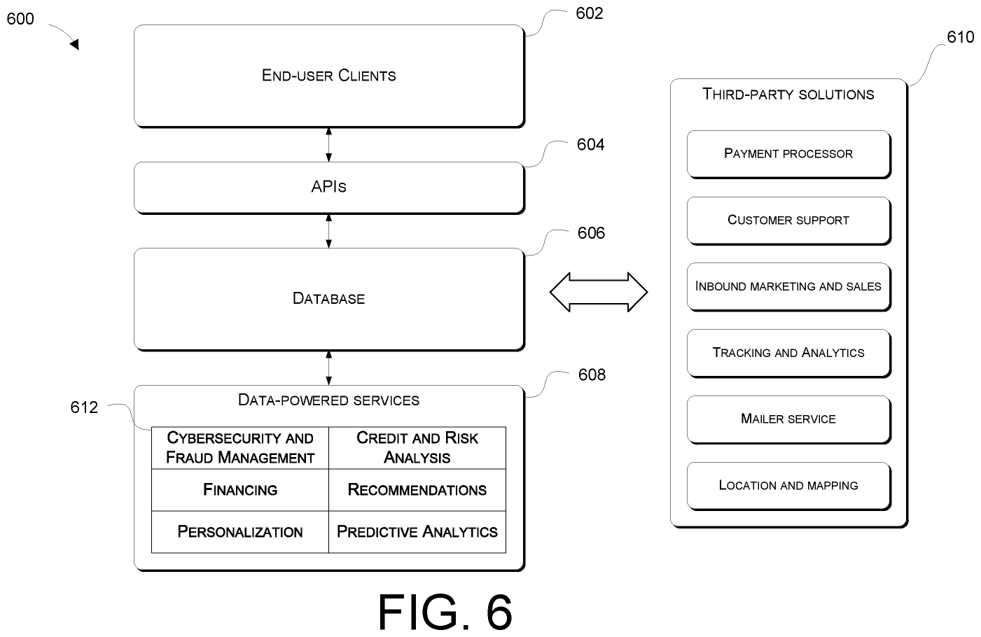

FIG. 6 illustrates an example of an architecture 600 for implementing embodiments of virtualized wholesaling. The architecture 600 may be implemented at least in part by the server 202 for implementing predictive analytics and machine learning.

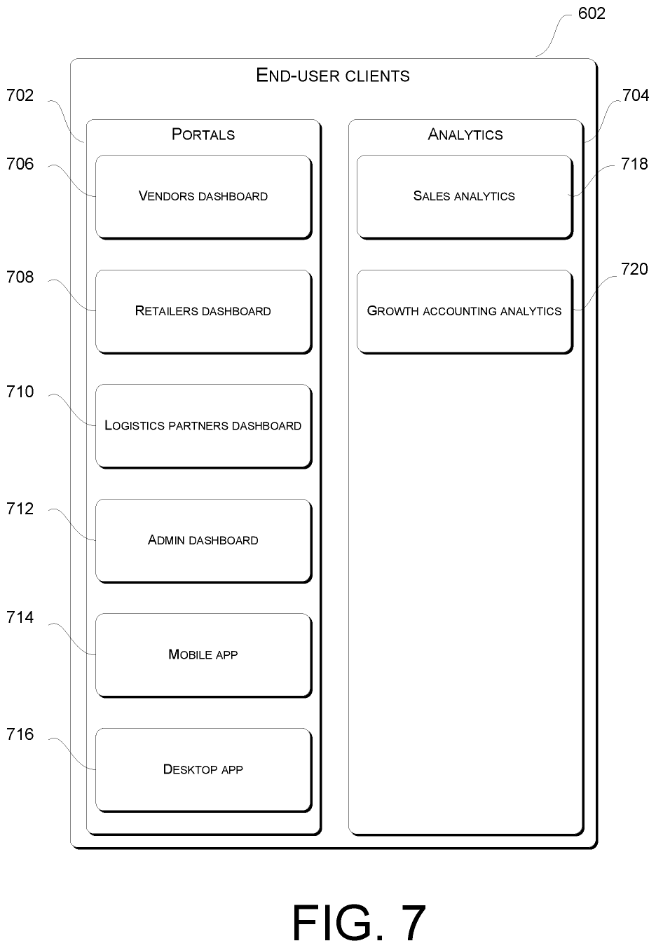

End-user clients 602 may include retailers, vendors, brands, distributors, and other entities as described herein. The end-user clients 602 are able to access a variety of information via portals and analytics as described below with regard to FIG. 7.

Application Programming Interfaces (APIs) 604 receive requests from the end-user clients 602 and convert the requests into a form that can be used to access data and services, for example data stored in the database 606 and data-powered services 608.

The database 606 stores a multitude of data in various datasets that are applied to the data models described herein. The data includes, but is in no way limited to, the datasets described above.

The Data-power services 608 represent backend services made available to end-user clients. Examples are, without limitation, cybersecurity and fraud management (e.g., security of stored and transactional data), financing (made available as an option to retailers of acceptable credit risk), personalization (customizable user experience), credit and risk analysis (for accepting a retailer or vendor as a customer but also feed financing), recommendations (product recommendations, brand recommendations, and/or retailer recommendations), and predictive analytics (including machine learning data models that can input a vast amount of data and output many different predictions driving recommendations, including retailer, brand, in-store logistical, and many, many more).

Third-party solutions 610 may include modules that actively interface with third party data sources and/or service providers. The illustrated examples, which are not limiting, include a payment processor module to manage payment for the retailer; a customer support module to provide support to retailers, vendors, and other subscribers to the virtualized wholesaling solution; an inbound marketing and sales module to create and/or manage content tailored to draw and retain customers; a tracking and analytics module to provide third-party analysis of data to reach conclusions as to the impact on sales, inventory management, etc. of various recommendations and initiatives resulting from the modeling described herein; a mailer service module to provide, e.g., promotional direct mailings; and a location and mapping module to provide route support for distributors and logistic analysis for where to warehouse products, how to get products to retailers cost- and time-efficiently, etc. “Modules” typically incorporate software executable on one or more processors but also may include hardware and human assets.

FIG. 7 illustrates examples of resources available to the end-user clients 602 that have access to data powered services such as those shown in the architecture of FIG. 6. For example, the end-user clients 602 may have access to portals 702 and analytics 704.

One or more of the portals 702 may be accessible to an end user client. For example, vendors may be able to access their site and its data and services via a vendors dashboard 706. Similarly, retailers may obtain access to their site via a retailers dashboard 708, logistics partners to theirs via a logistics partners dashboard 710, and administrative support to theirs via an admin dashboard 712. In some embodiments, any or all of the data and services described herein that are pertinent to the retailers, vendors, and logistics partners may be accessed via these dashboards.

A mobile app 714 represents the ability of an end-user client to access its site (e.g., dashboard) from a mobile device such as, without limitation, a smartphone, wearable device (e.g., smartwatch, personal digital assistant (PDA), AR/VR goggles), vehicle dashboard, or any other mobile device. A desktop app 716 represents the ability of an end-user client to access its site (e.g., dashboard) from other devices such as, and without limitation, a desktop computer, laptop, tablet, or any other computing device that does not support the mobile app 714.

The analytics 704 may include sales analytics 718 and growth accounting analytics 720. The sales analytics 718 offer not only visibility and transparency to retailers and vendors with respect to their own transactional data, but also give them the benefit of the powerful offerings of the various data models and modeling results that make up the virtualized wholesaling described herein. The growth accounting analytics 720 show retailers and vendors how their sales are benefiting, or could benefit more, based on the data gathered by the many sources set forth in this disclosure.

As described herein, virtualized wholesaling benefits small brands and vendors of small brands. However, virtualized wholesaling as a concept may be applicable to a wider variety of vendor, retail, and distributor size, as well as number of products and brands offered, using many of the principles advanced herein. Therefore, any specific embodiment or example described herein should be understood as exemplary and not limiting to their specific contexts.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. One or more non-transitory computer-readable media storing computer-executable instructions that, if executed by one or more processors, cause the one or more processors to perform operations comprising:
inputting, to a data model, a first dataset that comprises data of retailer site demographics and historical sales data at the retailer site;
inputting, to the data model, a second dataset that comprises sales data for a product at one or more remote retailers and a sales trend for the product at the one or more remote retailers;
running the data model on the first and second datasets;
deriving a timing for the retailer to offer the product for sale at the retailer site, based on the result of running the data model on the first and second datasets; and
outputting the timing.

2. The one or more non-transitory computer-readable media of claim 1, wherein the second dataset includes sales dates for the product relative to a holiday.

3. The one or more non-transitory computer-readable media of claim 1, the operations further comprising:
inputting, to the data model, a third dataset that comprises data of forms of advertising by the retailer of products in a product category that includes the product;
running the data model on the third dataset;
deriving a form of advertising for the retailer to employ in conjunction with offering the product for sale, based on the result of running the data model on the third dataset; and
outputting the form of advertising.

4. The one or more non-transitory computer-readable media of claim 3, the operations further comprising:
feeding back the result of running the data model on the first and second datasets as an input;
wherein the data model is run on the third dataset and the fed back result.

5. The one or more non-transitory computer-readable media of claim 1, the operations further comprising:
deriving a variable pricing scheme for the retailer to employ in conjunction with offering the product for sale, based on the result of running the data model on the first and second datasets; and
outputting the variable pricing scheme.

6. The one or more non-transitory computer-readable media of claim 1, the operations further comprising:
inputting, to the data model, a third dataset that comprises data of online consumer interest in the product; and
running the data model on the third dataset;
wherein the timing is derived based on the result of running the data model on the first, second, and third datasets.

7. The one or more non-transitory computer-readable media of claim 1, the operations further comprising:
inputting, to the data model, a third dataset that comprises recommendations from consumers related to buying products at the retailer that are in a product category that includes the product; and
running the data model on the third dataset;
wherein the timing is derived based on the result of running the data model on the first, second, and third datasets.

8. A method, comprising:
inputting, to a data model, a first dataset that comprises data of retailer site demographics and historical sales data at the retailer site;
inputting, to the data model, a second dataset that comprises sales data for a product at one or more remote retailers and a sales trend for the product at the one or more remote retailers;
running the data model on the first and second datasets;
deriving a timing for the retailer to offer the product for sale at the retailer site, based on the result of running the data model on the first and second datasets; and
outputting the timing.

9. The method of claim 8, wherein the second dataset includes sales dates for the product relative to a holiday.

10. The method of claim 8, further comprising:
inputting, to the data model, a third dataset that comprises data of forms of advertising by the retailer of products in a product category that includes the product;
running the data model on the third dataset;
deriving a form of advertising for the retailer to employ in conjunction with offering the product for sale, based on the result of running the data model on the third dataset; and
outputting the form of advertising.

11. The method of claim 10, further comprising:
feeding back the result of running the data model on the first and second datasets as an input;
wherein the data model is run on the third dataset and the fed back result.

12. The method of claim 8, further comprising:
deriving a variable pricing scheme for the retailer to employ in conjunction with offering the product for sale, based on the result of running the data model on the first and second datasets; and
outputting the variable pricing scheme.

13. The method of claim 8, further comprising:
inputting, to the data model, a third dataset that comprises data of online consumer interest in the product; and
running the data model on the third dataset;
wherein the timing is derived based on the result of running the data model on the first, second, and third datasets.

14. The method of claim 8, further comprising:
inputting, to the data model, a third dataset that comprises recommendations from consumers related to buying products at the retailer that are in a product category that includes the product; and
running the data model on the third dataset;
wherein the timing is derived based on the result of running the data model on the first, second, and third datasets.

15. One or more non-transitory computer-readable media storing computer-executable instructions that, if executed by one or more processors, cause the one or more processors to perform operations comprising:
inputting, to a data model, a first dataset that comprises data of historical sales data at a retailer;
inputting, to the data model, a second dataset that comprises sales data for a product at one or more remote retailers;
running the data model on the first and second datasets;
deriving a timing for the retailer to offer the product for sale at the retailer site, based on the result of running the data model on the first and second datasets;
outputting the timing;
inputting analytics from a third-party source related to new retail sales data for the product; and
updating the second dataset with the new retail sales data; and
rerunning the data model with the updated second dataset.

16. The one or more non-transitory computer-readable media of claim 15, the operations further comprising:
inputting, to the data model, a third dataset that comprises recommendations from consumers related to buying products at the retailer that are in a product category that includes the product; and
running the data model on the third dataset;
wherein the timing is derived based on the result of running the data model on the first, second, and third datasets.

17. The one or more non-transitory computer-readable media of claim 15, the operations further comprising:
inputting, to the data model, a third dataset that comprises data of forms of advertising by the retailer of products in a product category that includes the product;
running the data model on the third dataset;
deriving a form of advertising for the retailer to employ in conjunction with offering the product for sale, based on the result of running the data model on the third dataset; and
outputting the form of advertising.

18. The one or more non-transitory computer-readable media of claim 17, the operations further comprising:
feeding back the result of running the data model on the first and second datasets as an input;
wherein the data model is run on the third dataset and the fed back result.

19. The one or more non-transitory computer-readable media of claim 15, the operations further comprising:
deriving a variable pricing scheme for the retailer to employ in conjunction with offering the product for sale, based on the result of running the data model on the first and second datasets; and
outputting the variable pricing scheme.

20. The one or more non-transitory computer-readable media of claim 15, the operations further comprising:
inputting, to the data model, a third dataset that comprises data of online consumer interest in the product; and
running the data model on the third dataset;
wherein the timing is derived based on the result of running the data model on the first, second, and third datasets.
